(19) United States
(12) Patent Application Publication
(10) Pub. No.: US 2013/0347111 A1
(43) Pub. Date: Dec. 26, 2013

(54) SYSTEM AND METHOD FOR DETECTION AND PREVENTION OF HOST INTRUSIONS AND MALICIOUS PAYLOADS

(71) Applicants: Yaniv Karta, Ramat Gan (IL); Elia Yehuda, Ramat Gan (IL)

(72) Inventors: Yaniv Karta, Ramat Gan (IL); Elia Yehuda, Ramat Gan (IL)

(73) Assignee: Zimperium, Tel Aviv (IL)

(21) Appl. No.: 13/925,904

(22) Filed: Jun. 25, 2013

Related U.S. Application Data
(60) Provisional application No. 61/663,637, filed on Jun. 25, 2012.

(51) Int. Cl. H04L 29/06

(52) U.S. Cl. CPC H04L 63/1441
USPC 726/23

(57) ABSTRACT

A computerized system for preventing host intrusions on a communication device. The device is wirelessly connected to a wireless communication network. The system includes a computer readable management software module configured to analyze malicious payloads. The management software module includes an asset manager module configured to assign updates to the communication device, a device database module configured to describe the communication device characteristics and a build database module configured to automate software builds of the communication device core operating system. The management software module also includes a component builder module configured to run a plurality of instruction sets to establish a build environment for the communication device according to the communication device characteristics, a configuration manager module configured to build the instruction sets and an operating system product module configured by the build database module as part of a build process triggered by the asset manager module.

### FIELD OF THE INVENTION

The present invention generally relates to mobile application security and in particular to the prevention of host intrusions and the prevention of malicious payloads.

### BACKGROUND OF THE INVENTION

Systems for detection and prevention of network intrusions constantly monitor the communication that flows in the networking environment they protect. They intercept or drop suspicious network traffic, as well as issue an alert to the network administrator. The process of intercepting or dropping suspicious traffic ensures the security of the network.

Malicious payloads are usually carried in a buffer that exploits vulnerability in an operating system or in an application component. These payloads are responsible for exercising the vulnerability by altering normal processor flow to execute an attacker's code.

Host based applications involve client side threats to files, interfaces, etc., which typically happen locally. For example, in some scenarios a virus attack, is not an attack on the network, rather it is a personal attack, involving more intense ways to exploit processes and the execution of running processes within the operating system. Though host attacks may be executed via the network, in many cases the host attack is accomplished via payload web kit vulnerability or email attachment. For example, an attacker can send a user, such as a mobile device user a link to a web site and if the targeted user enters the web site his device will be hacked. Yet another example of a host attack may be after downloading a payload by the user, the payload will cause the user's browser to spawn a process that will make available to the attacker the same conditions as are available to the user. The attacker will be enabled to do whatever the user is allowed to do on his device for example to steal all the user's certificates.

Host based attacks can be divided into several categories that may result in:
Elevation of Privileges (EOP)
Code execution (CEX)—execution of arbitrary code.

### SUMMARY OF THE INVENTION

The present invention provides a host intrusion detection and prevention system on both client and server side, implemented for electronic devices, such as mobile phones, smart phones, tablets or any mobile computing platforms known in the art.

In one embodiment of the present invention, a low level component the system monitors the execution of each and every application, and monitors its behavior.

In yet another embodiment of the present invention, the intrusion prevention system gathers a whitelist of processes that are allowed to breach normal execution behavior.

In yet another preferred embodiment of the present invention, the whitelist may be updated from a daemon privileged process.

In yet another embodiment of the present invention, the host intrusion prevention predicts malicious payloads and prevents execution of unknown malicious payloads to services or processes running on the electronic device platform.

In yet another embodiment of the present invention, the host intrusion prevention system (IPS) analyzes potentially-malicious payloads and sends them to a cloud-based behavioral engine such as an automatic behavioral engine, defined as an engine used for sampling and for behavior forensics and analysis.

In yet another preferred embodiment of the present invention, a syscall table is guarded on a kernel level.

In yet another preferred embodiment of the present invention, an execution flow of malicious code may be automatically detected and prevented.

In yet another preferred embodiment of the present invention, a previously unknown malicious application may be prevented based on a post-execution behavior model, based on behavioral analysis performed after code execution.

In yet another method embodiment of the present invention a cloud software management system is used to automatically build software modules for the target device, according to the device characteristics stored in the database.

In yet another preferred embodiment of the present invention, the intrusion prevention system uses rules based on process execution patterns defined and distributed by a cloud based policy generator.

In yet another preferred embodiment of this invention, the rules for malicious pattern behavior are generated on a cloud software management service, as described below.

In yet another preferred embodiment of this invention, mathematical tools are used to solve NP-hard (Non-deterministic Polynomial-time hard) problems. NP hard, in computational complexity theory, is a class of problems that are solvable in a “reasonable” amount of time.

A computerized system is disclosed for preventing host intrusions on a communication device. The device may be wirelessly connected to a wireless communication network. The system includes a computer readable management software module configured to analyze malicious payloads. The management software module includes an asset manager module configured to assign updates to the communication device, a device database module configured to describe the communication device characteristics and a build database module configured to automate software builds of the communication device core operating system. The management software module also includes a component builder module configured to run a plurality of instruction sets to establish a build environment for the communication device according to the communication device characteristics, a configuration manager module configured to build the instruction sets and an operating system product module configured by the build database module as part of a build process triggered by the asset manager module.

In addition to network-based intrusion detection and prevention, the prevention of host intrusion, such as behavioral observation and anomaly prevention for mobile application security processes, acts to monitor the operating system's behavior and to alert to anomalies.

According to one embodiment of the present invention there is provided a detection engine which combines a form of inference with a host IPS. The inference provides a solution for the non-root privileges, and has the same effect or even more precise than as modifying the privileges but without using a kernel object.

In another embodiment of the present invention, a low-level component uses targeted compiled kernel objects for a target operating system of an endpoint device being monitored, such as specific kernel versions.

Instead of compiling to each kernel for the build machine, a variety of versions are created. A virtual machine which has the kernel object running on it is implemented, and if one downloaded a document from the Internet, or anything that could arbitrarily be used to implement code, it would run over the cloud over the virtual machine and the kernel object would be responsible to make sure it did not alter the execution. For example, the attacker emailed a PDF and the user received it. If the PDF has been altered, the system does not allow the user device to open the PDF. The PDF is transmitted to the cloud and it is inspected with the kernel object. The PDF is expected on the device when opened. If the code execution was altered, the virtual machine can detect it and stop it.

According to one embodiment, the present invention monitors the low-level functions of the operating systems, for example by monitoring the syscalls, which may be very intrusive, i.e., disruptive to the user. This is usually done when threats are imminent, large and high-level. High and low level functions are defined according to their proximity to a human language i.e. the closer a function is to human language, the higher-level the function. The closer it is to machine language, i.e. zeroes and ones, the lower-level the function. The level refers to how far down the call stack the function is located. When a program starts, the operating system calls the main or top level, which consists of calls to the next lower level functions. Each in turn calls other functions to do more basic tasks, which end up calling functions in operating system, e.g. to open a file. The low level functions are the system functions which abstract the data and schedules it for further processing or serialization to the hardware resource in case of a file.

In a host intrusion the attacker usually needs to gain privileges allowing execution on the target operating system. For example, in order to run the attack on every device the attacker needs to do it without the privileges. Therefore, instead of connecting from the kernel, the attacker is capable of an attack without the kernel object. As a result, when there is a host threat, and the execution has been altered, the user needs to know whether the alteration was legitimate or not.

The interfaces are the first frontier and the host is the second frontier. As some interfaces (e.g. Bluetooth and WiFi) may include a number of elements an attacker may use to penetrate the user's device, and the attacker may manage to escape detection on the first frontier. However, according to the present invention the attacker may be detected on the second frontier i.e. the host. The detection part is relevant to training, but the prevention is relevant to the kernel object. One does not have permission in user mode to stop other processes from doing something, so even if the IPS detected it, it could not stop it because the kernel object has not been accessed. According to some embodiments of the invention there are provided a number of policies used to stop and prevent attacks, which are accomplished by bypassing the kernel object. Instead of executing the altered code it is stopped before execution. The attempted execution of the altered code does not work and abnormal execution stops and handled further according to policies.

For example, if the user enters a website that has a hidden frame as part of an attack, the hidden frame typically pushes a malicious payload such as described on FIG. 4, which is detected and stopped according to the present invention method and system. According to another embodiment of the present invention the user may be notified that the hidden payload was stopped, without causing any affect on the rest of the webpage.

For the kernel object, a build system may be used so that a used code will be agnostic to version or platform, and the object can compile to multiple systems. It has been developed as part of the present invention, so the same kernel object is built for all versions. Historically, developers used build automation to call compilers and linkers from inside a build script. Build management tools provide more automation of the build process. The distributed build process has the machine intelligence to understand the source code dependencies in order to send the different compile and link steps to different machine versions. A build automation tool is configured to manage these dependencies in order to perform distributed builds. For prevention of host attacks, one needs to be in the kernel to apply all the prevention policies, even though the kernel can be skipped in the detection phase. Detection can be done for example, without root privileges. According to one embodiment, the present invention is able to detect the alteration of execution without using the syscall table.

If the developer wants to add another build to the system he may add another row to the database. The database also has the build schedule, which correlates the different settings with build components into a build ID. The asset manager is the build product. The component settings have different uniform resource locators (URL's). The asset manager takes the settings from the database and generates the code. The build database has a build schedule which correlates the different settings with corresponding components into a build ID. The settings are taken from the database in order to complete the build. A header file is generated and the code is compiled to build a package for the specific component that was defined. IP addresses and ports are used as a means of communication, for example, for the server. This is how the components are configured to communicate with the server.

Instead of compiling to each kernel for the build machine, a variety of versions are created. A virtual machine which has the kernel object running on it is implemented, and if one downloaded a document from the Internet, or anything that could arbitrarily be used to implement code, it would run over the cloud over the virtual machine and the kernel object would be responsible to make sure it did not alter the execution. For example, the attacker emailed a PDF and the user received it. If the PDF has been altered, the system does not allow the user device to open the PDF. The PDF is send to the cloud and it is inspected with the kernel object. The PDF is inspected on the device when opened. If the code execution was altered, the virtual machine can detect it and stop it.

The build database sets up all the environments to work, for example transparently. If the developer knows that a certain PDF was already inspected he does not have to inspect it. It can be offloaded. If it has the same signature it need not be re-inspected. The result is already known. If it can be searched locally and one sees that structure it is malformed, one can say this structure is suspicious. It doesn't mean it's vulnerable or contains an attack, but it does mean it's suspicious. If it is suspicious then it will be sent to the cloud. If it isn't suspicious it will be opened locally. According to one embodiment, the essence of the present invention is that one is able to detect the codes' execution alteration in real time and prevent it from actually executing the code. Prior art solutions are based on signatures and therefore need to know the threat in advance. Moreover, prior art solutions take the threat and perform forensics on it to sign certain parts of it and look for the signature on that part. The present invention can detect whether or not the codes execution has been altered. So instead of signing the payload one can detect automatically in real time and prevent it, instead of relying on hashes of real threats one can detect unknown or un-hashed threats by detecting code execution alteration. According to the present invention method and system, one can function without kernel privileges or function with kernel privileges in offloading the detection of the device, but still send it to a virtual machine that has the kernel object. For the device one doesn't need the privileges to install the kernel for endpoint device protection.

In the present invention, the following terms are defined for sake of clarity:

Application whitelisting is a computer administration practice used to prevent unauthorized programs from running. The purpose is primarily to protect computers and networks from harmful applications. The whitelist is a list of applications that have been granted permission by an administrator. When an application tries to execute, it is automatically checked against the list and, if found, allowed to run. An integrity check measure, such as hashing, is generally added to ensure that the application is in fact the authorized program and not a malicious or otherwise inappropriate one with the same name.

A checksum or hash sum is a small-size datum, i.e., the sum of the o's and 1's in a segment of source code, computed from an arbitrary block of digital data for the purpose of detecting errors that may have been introduced from one instantiation to another.

The syscall table is generally an array of function pointers. These function pointers can be redirected to point to functions implemented in a rootkit. A kernel rootkit is malware that alters the kernel to hide its presence and function.

A child process in computing is a process created by another process (the parent process). A child process inherits most of its attributes, such as file descriptors, from its parent. A child process is typically created as a copy of the parent, using the fork system call. Each process may create many child processes, but will have at most only one parent process. If a process does not have a parent this usually indicates that it was created directly by the kernel.

Typically, the very first process, called init, is started by the kernel at booting time and never terminates. Other parentless processes may be launched to carry out various daemon tasks in userspace. Another way for a process to end up without a parent is if its parent dies, leaving an orphan process, but in this case it will shortly be adopted by init.

Root is the conventional name of the user who has all rights or permissions (to all files and programs) in all modes (single- or multi-user). The root user can do many things an ordinary user cannot, such as changing the ownership of files and binding to network ports numbered below 1024. Root is the only user account with permission to modify the root directory. The first process bootstrapped, usually called init, runs with root privileges. It spawns all other processes directly or indirectly, which inherit their parents' privileges. Only a process running as root is allowed to change its user ID to that of another user; once it's done so, there is no way back. “Dropping root privileges” (as soon as an attack is suspected) is often done as a security measure to limit the damage from possible contamination of the process. Root privilege is equivalent on windows platform as Administrator account which have enough privileges to install, execute and interract directly with the kernel.

Objects can either be Kernel objects or Executive objects. Kernel objects represent primitive resources such as physical devices, or services such as synchronization, which are required to implement any other type of operating system (OS) service. Kernel objects are not exposed to user mode code, but are restricted to kernel code.

To avoid having fixed addresses for the syscall table, mechanisms such as ASLR has been developed, which randomizes the addresses of the syscall, making it harder for an attack to work.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIG. 1 is a schematic block diagram illustrating the interaction between system components for the automatic build of the host intrusion prevention system, core operating system components for target devices, constructed according to the principles of the present invention;

FIG. 2 is a schematic block diagram illustrating the interaction between system components for host intrusion prevention system on mobile devices, constructed according to the principles of the present invention;

FIG. 3a illustrates the different components developed to catch malicious payloads and host based intrusion scenarios with mutual contingency and redundancy, constructed according to the principles of the present invention;

FIG. 3b shows the active components on a user-mode solution which does not contain kernel enforcement and verification, and may use virtual cloud instance to examine suspicious files, while detection is done by inference engine, constructed according to the principles of the present invention;

FIG. 4 is a UML sequence diagram, describing flow of execution for ‘heap-spray’ attacks on webkit based web-browsers in regards with the active components while detecting and preventing the attack, constructed according to the principles of the present invention; and

FIG. 5 shows integer overflow kernel exploitation on 32 bit address spaces, using 2 different variables, this problem generalizes a method for local privilege escalation, used by many exploits, constructed according to the principles of the present invention.

All the above and other characteristics and advantages of the invention will be further understood through the following illustrative and non-limitative description of preferred embodiments thereof.

### DETAILED DESCRIPTION OF PREFERRED EMBODIMENTS

The present embodiments relate to network application security, more particularly, but not exclusively, to an intrusion prevention system, device and method, which can operate efficiently on mobile devices and platforms.

The present invention system and method differs from traditional countermeasures which exists today such as Address Layer Randomization (ASLR), stack cookies and other, by that it provides countermeasures of the attacks once recognize instead of making the attack difficult by placing ‘obstacles’ on the attacker such as randomization of addresses. Instead the intrusion prevention system uses an inference engine to detect and prevent the malicious activities using methods, which are not known in the art. The novelty of the current invention is the ability to deterministically block attacks using low level system components that runs with high privileges, the detection itself may in some embodiments still run on user mode, allowing to gain better accurate performance as illustrated on comparison graphs below.

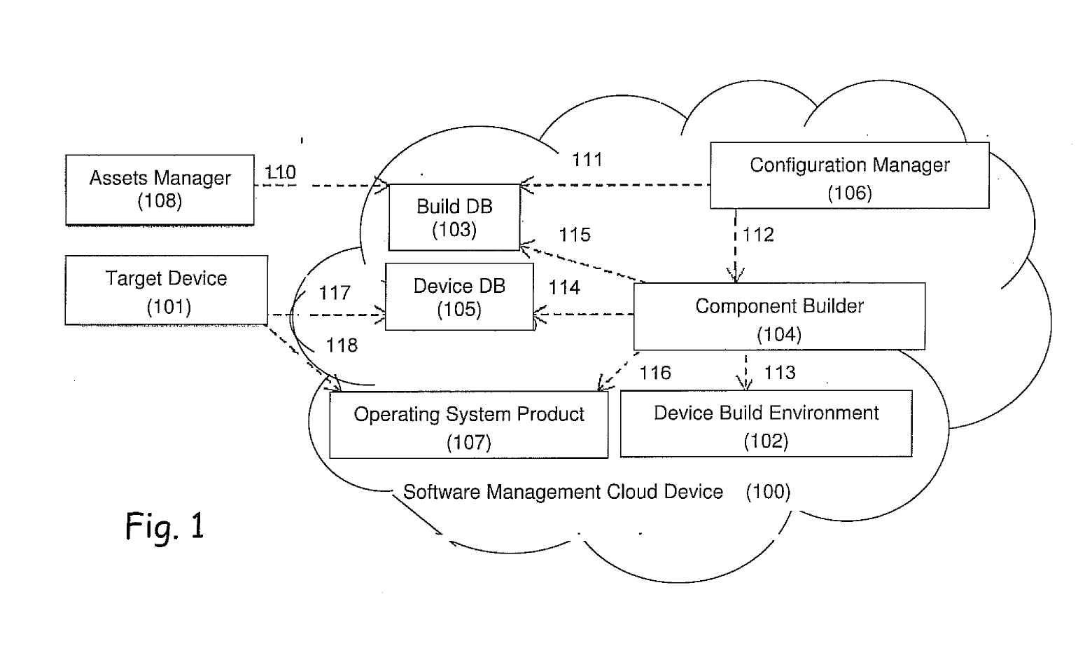

FIG. 1 is a schematic block diagram illustrating the interaction between the core operating system components and the target devices (e.g. mobile phone, tablet, laptop etc.) constructed according to the principles of the present invention. According to one embodiment of the present invention there is provided a Software Management Cloud Device 100 which is an online environment, responsible for automating software to build for processes or low-level system components such as the inference engine, or communication engine, which are device and configuration dependent.

Target Devices 101 may be one or more electronic devices. Such devices include for example a mobile phone, tablet, laptop, or other portable device. The devices run an operating system, and allow connectivity to the remote Software Management Cloud Device 100.

An Assets Manager 108 is a software module that may reside for example on a user endpoint machine or within the Software Management Cloud Device 100, and is responsible for configuration and assignments of updates and patches to core operating system components on one or more Target Devices 101

Device DB 105 is a database component running on the device software management cloud 100 and is used among other purposes for describing the device characteristics and hardware and software configuration per Target Device 101. Build DB 103 is a database responsible for automation of software builds, versioning, configuration, compilation, linkage and deployment of software updates relevant to the core operating system of the Target Device 101. Component Builder 104 is a software component module running on Cloud 100, and is responsible for running an instruction set to establish a build environment for Target Device 101, based on the device characteristics described in the Device DB 105. This allows flexible automation of the software management process.

Configuration Manager module 106, located for example on the Software Management Cloud Device 100, is responsible for automatically building according to package based configuration and may be executed by a target Component Builder 104 which is responsible for the component in the package and the successful build and test of each component composing the overall package. According to one embodiment of the invention, an overall result of the build process is an automatic build environment which generates instruction sets for a build system such as cmake or autotools to automatically build the package for the target platform. These instruction sets may embed automatically generated build scripts, programs and instructions, which use the Device Build Environment 102 to generate the software patch or product described as an Operating System Product 107.

Operating System Product 107 is the product of the build process as will be described below, and produced by Component Builder 104 during an event triggered by Assets Manager 108. Operating System Product 107 may be a binary patch to an operating system component or a third party application, process, or software module, or any other system component, or a complete operating system build which is known in the art.

### Flow of Execution:

Assets Manager 108 issues software requests 110 for software updates or patches for a specific device type or types by a hardware, software or component vendor describing the Target Device 101. Software requests 110 are processed on Cloud Device 100 and inserted into Build DB 103. Configuration Manager 106 may be triggered or may poll the requests and constructs a set of instructions, then passes the construction requests 112 for Component Builder 104. Component Builder 104 loads a template for the target build environment 113. If no template is available, Component Builder 104 uses a set of queries 114/115 to generate a build template 116 for Target Device 101. Using build template 116, the instruction sets are run to produce final Operating System Product 107, which is signed and encrypted.

When Target Device 101 connects 117 to Cloud 100, Device DB 105 is queried, and if a new update exists, it notifies the device of such an update. Target Device 101 then downloads 118, decrypts, verifies and executes the selected update on the target machine.

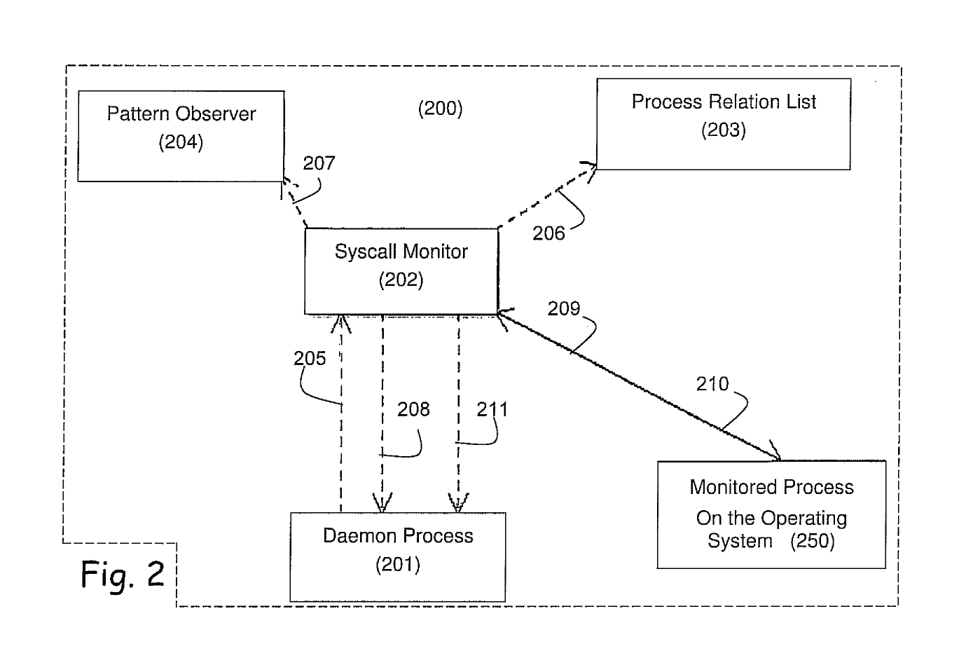

FIG. 2 is a schematic block diagram illustrating the interaction between the system components and modules, constructed according to the principles of the present invention. The modules described may be launched on a mobile device 200, such as the Target Device 101 of FIG. 1. A daemon process 201 describes a process with high privileges that monitors operating system and network/process activities. A syscall monitor 202 is an operating system internal object that is responsible for monitoring internal operating system calls. According to one embodiment of the present invention, daemon process 201 connects to the Syscall Monitor 202 via sysfs and transfers 205 a list of process pairs to monitor, with a rule set applied to each. Sysfs is a method for transferring data that is known in the art.

The list of process pairs are stored on a Process Relation List 203, which is responsible for the collection of the processes allowed to execute from parent processes. This allows the system to enable strictly protected processes to execute only child processes that are preconfigured. Daemon process 201 also transfers patterns to observe to Syscall Monitor 202. Daemon process 201 configures 207 the Pattern Observer 204. Pattern Observer 204 is responsible to disable malicious patterns from executing within the operating system.

Syscall Monitor 202 notifies the Daemon Process 201 of the current system state 208. When an arbitrary Monitored Process 250 is executed on the Operating System, the process uses a core operating system syscall invocation 209, which in turn is inspected by Syscall Monitor 202. If the executing Monitored Process 250 is monitored, then only allowed syscall entries may be used by the process. For any unknown process, Pattern Observer 204 will notify misuse of the process by comparing sequences of execution and/or parameters, which may put the system at risk. The arbitrary Monitored Process 250 may get a return value 210 from Syscall Monitor 202, which may be returned from the operating system function call or from Syscall Monitor 202 itself.

According to one embodiment of the present invention, the Syscall Monitor 202 also notifies 211 Daemon Process 201 of any anomalies detected or threats prevented by Syscall Monitor 202.

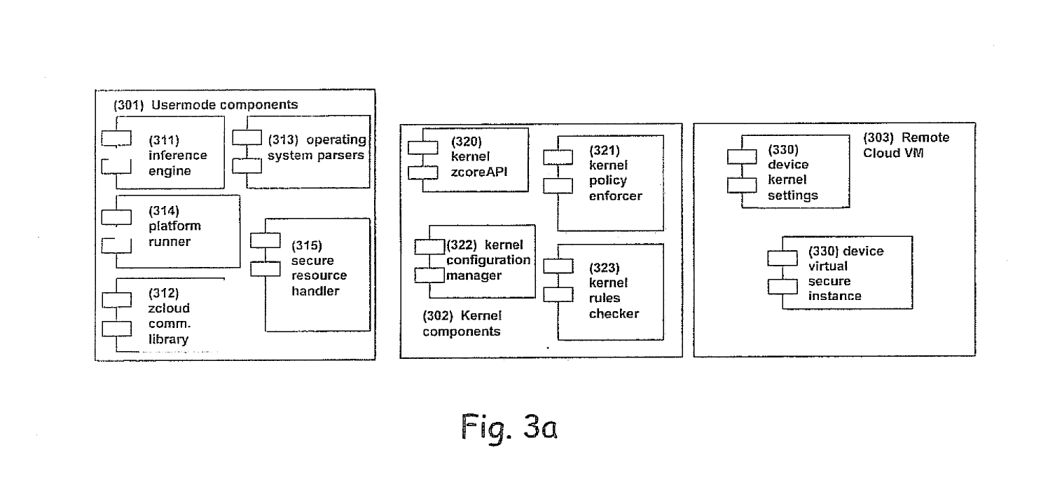

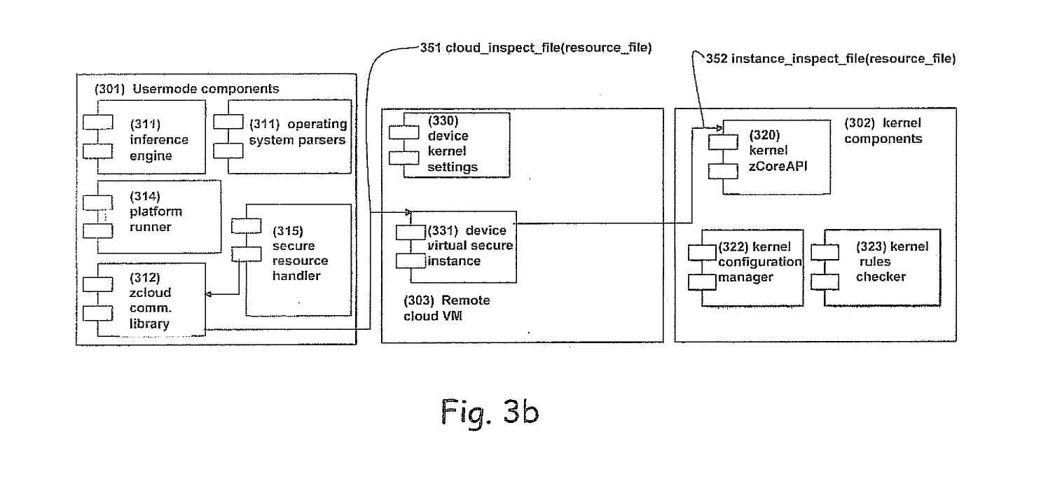

FIG. 3a illustrates the different components developed to catch malicious payloads and host based intrusion scenarios with mutual contingency and redundancy, constructed according to the principles of the present invention. The various components and their relations may be controlled using an automated build system to provide different packages for various configurations, which may be device specific or generic. User-mode components 301 do not require special privileges, such as operating system parameters 313, which may be parameters collected using performance counters or synthetically created variables, which correlate to an indifferent system behavior.

The use of those parameters is abstracted, correlating them for transparent usage by the inference engine 311. The platform runner 314 wraps the daemon process with the user interface and basic operational code. A zcloud comm. Library 312 is responsible for the events/commands interface used for communication with the cloud servers and also for tunneling or complex execution on the cloud as described later. A separate secure resource handler 315 may be used, such as a PDF viewer, which may inspect a specific file or resource type for abnormal behavior. Suspicious files may be executed on a secure virtual environment on the cloud to verify the hazardous file is indeed malicious. When kernel components are local, it may contain several components wrapped into a kernel object. The Kernel zcoreAPI 320 facades the calls and the interface to all kernel components used for interaction from usermode components 301, for applying configurations, whitelisting, rule-setting and other operations requiring such interfaces with kernel components 302.

Kernel zcoreAPI 320 interacts with kernel policy enforcer 321 when a threat is detected, to provide a pre-configured response as described in threat-response-matrix settings. The kernel configuration manager 322 is responsible for saving those settings, for the kernel components to access on runtime. The kernel rules checker 323 uses a serialized set of logic to verify that a threat is actually real, and not ‘similar’ to what was detected. This process may be exhaustive of CPU, since memory regions of the process are scanned and compared to normal behavior patterns. To avoid calling it frequently only abnormal behavior detection will trigger it.

When kernel components 302 are not available, a virtual instance reflecting the endpoint device behavior 303 is used, which contains generic configurations and settings for the device deployment kernel settings 330, which includes the memory of the device, default applications such as viewers and the virtual instance of the device 331, which is used securely to scan malicious files found on the endpoint device, when no kernel protection is available for forensics purposes. Since a virtual instance of the device 303 may be running, selective kernel components 302 may run on the virtual instance as illustrated on FIG. 3b.

FIG. 3b shows the active components on a user-mode solution which does not contain kernel enforcement and verification, and may use virtual cloud instance to examine suspicious files, while detection is done by inference engine, constructed according to the principles of the present invention. FIG. 3b shows a different configuration of packages used for deployment of the host IPS, which uses secure resource handler 315 to detect a suspected file, and transfer it via communication library 312 to the cloud 351, so that it may be inspected further on a virtual instance of the device, with kernel object running on a virtual instance 303.

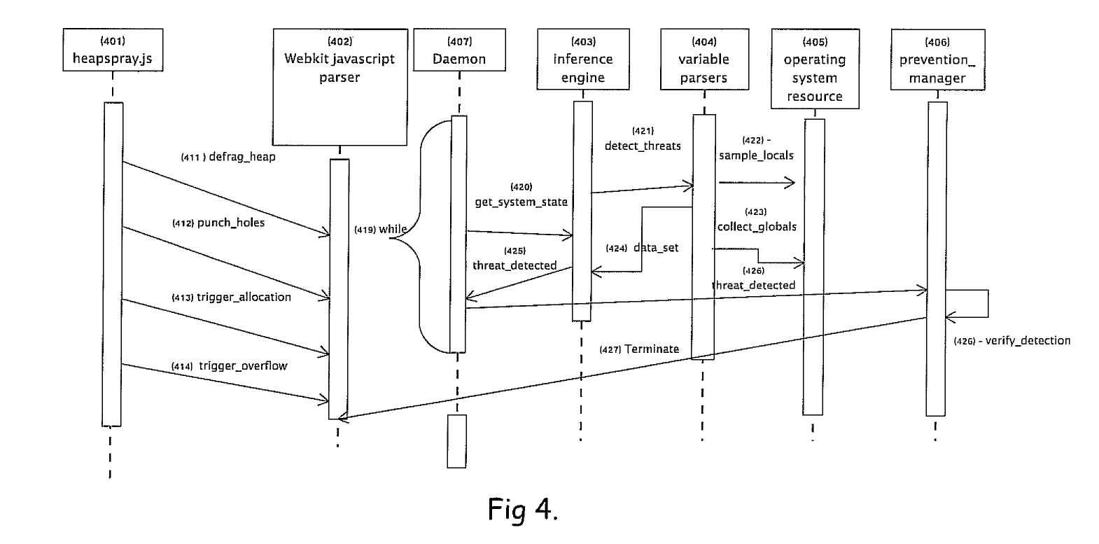

FIG. 4 is a UML sequence diagram, describing flow of execution for ‘heap-spray’ attacks on webkit based web-browsers in regards with the active components while detecting and preventing the attack, constructed according to the principles of the present invention.

A client side javascript code that tries to exploit the webkit based webbrowser 402 is called heapspray 401. It is a webkit based browser object, which may be any browser that runs on mobile devices, such as phones, tablets, laptops, glasses or any other smart device known in the art. The browser itself, may be for example google chrome, firefox, default android browser, safari or any other browser using webkit library or similar library, to parse the javascript code and execute it. The daemon process 407 described in FIG. 2 as 201, is responsible for communication and inference of threats and interacting with different components of the system, such as the kernel driver, as explained in FIGS. 3a and 3b. The inference engine 403 is responsible for the detection of threats in realtime, by triggering or sampling variables that indicate a vulnerability is being exploited.

The variable parsers 404 decouple the various operating system dependent variables from inference engine 403, making it easier to port logic across similar systems. Operating system resource 405 is where specific variables are processed or collected to infer that anomaly happened. It may result in allocations that are not normal or an exceptional number of system FAULTS, which may be collected from regular application privileges. The prevention manager 406 is a part of the kernel object described earlier. The malicious javascript will first try to def rag the heap 411 by allocating consequent sets of memory until the end of the heap is reached. This technique allows the attacker to control a large enough memory block so that it may be altered to reflect an ‘executable’ structure of code.

Selectively de-allocating the memory regions' holes of memory that weren't freed may create a ‘sled’ leading to later code execution. The punch_holes 412 method enables the ‘sled’ to proceed through the memory, making sure it is consequent on the end of the heap, allowing the next step, trigger allocation 413 to occur. The buffers are orchestrated to exhibit the behavior of an external structure allocated, for instance a JCell object on javascript. The next step of allocation is constructing the shellcode, before overflow is triggered 414.

Preparing the shellcode usually requires inner understanding of the way the structures are used on the webkit library, in order to build a virtual function table, which exhibits the same behavior as the construction of the buffer. This is done to fit the structure in memory of an object or a function that may be used by the webkit. The code may be prepared using for example ascii-256 encapsulation of the data (“\x4d\x44\x11\x43 . . . ”). After constructing the buffer, one preferably triggers the jump to the shellcode that was constructed. For that one may use heapspray technique 401, which will use a buffer containing a conditional jump instruction to a heapspray address, thus gaining code execution on a local webkit application, such as browser permissions.

Daemon process 407 is responsible for real-time sampling of information on the device, parsing and correlating the data, communicating with cloud servers and control the endpoint device using event command mechanism. It runs in a “while” loop 419, triggering the inference system (403) to decide on the current system state. Inference engine 403 detects the threats and their probability, allowing sophisticated end cases to be ruled out of the decision process by verification by prevention manager 406. While loop 419 periodically gets the system state 420, but also gets notified by registered events of callback functions, allowing multiple inference algorithms to detect the various threats. Get_system_state 420 inspects each process in the system, with objective parameters that are related to that process and are accessible from usermode application privileges, such as memory and performance counters, with a large enough search space to complete statistical depth search for correlation of events.

Inference engine 403 uses various algorithms to conduct cross feature extraction, among other techniques, to handle detection and decision process from daemon process 407 boundaries. When system state is being inspected inference engine 403 uses variable parsers 404, which associatively correlate the parameters on the target operating system with a reference variable from the operating system to loose coupling (dependency) of the algorithm with operating system's specific variable when detecting threats 421. The parameters collected by the parsing component are local 422 or global 423, and are mapped from different resources within host operating system 405. The host operating system may be Linux, BSD, Windows, XNU, OSX based operating system such as Android, iOS, etc.

When inference engine 403 detects a threat from the collection of the variables, it informs daemon 407 of the threat and the probability 425, which in turn asks the kernel object to use prevention manager 406 to verify the detection of local exploit 425, and to take action for example according to threat-response-matrix. Such actions may be: stop context for process and dump (snapshot); terminate 426; breakpoint process and conditionally track memory region (advanced forensics); and other methods which allow a professional investigator to detect the malicious nature of the attack.

On devices that do not contain a kernel object for protection, “bring your own device” (BYOD) devices, the detection part will still work. Yet such devices may decrease their trust level in the organization, as they may be considered infected and increase the risk to the organization.

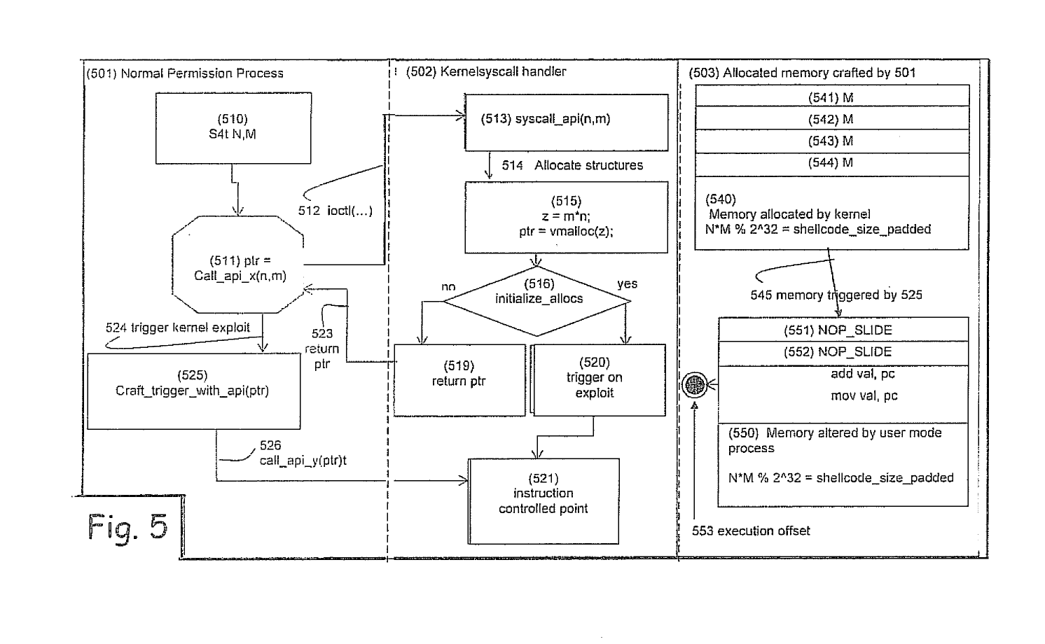

FIG. 5 is an illustration of an integer overflow kernel exploit flow diagram, constructed according to the principles of the present invention. This problem generalizes a method for local privilege escalation, used by many exploits (see the following link).

UMl http://www.ibm.com/developerworks/rational/library/3101.html

FIG. 5 explains a high level process of arbitrary code execution on the kernel using integer overflow allocation bug, which can be found on various operating system's kernels such as Windows™, Linux based, BSD, Mac OSX™, Apple's iOS™ and others. A 32 bit address space is assumed, which is convenient enough for the general concept, but the basic idea behind it applies also for 64 bit machines.

A normal permission process 501 is running with local privileges. It may be a part of a shellcode generated and executed via the flow described in FIG. 4b.

The first step 510 sets N to be a number, which will potentially cause the kernel to allocate according to what variable N structs in memory. Many syscalls and API functions on different plaforms support variable structs as parameters, allowing interfaces to generalize operations on different resources. For instance, struct sockaddr is a variable size structure when calling api functions. The second parameter to be set is N, which is the target structure for this allocation. The size of the target buffer should be a result of X mod mul. For instance, if struct size is 8 and N=2̂30, allocation in kernel will request 0 bytes due to an integer overflow, when multiplying 2̂30*2̂3.

The next step 511 selects the right struct supported via an API call, preferably one that does not verify ranges of integers. It is called api_x, which may be a syscall 513, a direct read/write from the kernel object, a non-direct buffer, which is passed through to an api, a syscall or any other method known in the art.

512 is an ioctl or direct read/write to a file descriptor, or anything else which triggers a low level syscall handler for invocation, which relates to the usermode function originally called 511. 514 causes the kernel object to allocate memory of size n*m, when n>2̂30 overflows to 0. Thus the desired ‘padded’ buffer size can be crafted with N, where N is (2̂30)+(padded_buffer_size/M). 515 allocates the instructed buffer. Due to the overflow it allocates exactly the size of buffer needed for the exploit to work. The next step for an attacker depends on the exploited code. If it initializes the structure after allocation 516, that might be a bad thing for the attacker. It will reduce the ways to gain code execution, yet it may trigger an exploit 520 on the spot, causing the initialization to fail on a well crafted address. Most attacks will continue the flow with 519, where the user process receives an indirect address, a pointer or a pointer to a pointer of the address. The reference to the memory being returned according to each operating system, is now accessible for 525 to craft the structure in memory as shown on 503 for the trigger exploit code 524 by pre-calculating the point at which execution and control over registers and variables is possible, transforming the memory allocated for the structures 503 to transform from structured memory 540 to executable memory region 550. Structured memory 540 typically comprises multiple modules 541-544. Executable memory region 550 typically comprises modules such as NOP_SLIDE 551 and NOP_SLIDE 552.

This allows 525 to call the next api, call_api_y 526, which uses the structure. Assuming it contains n entries, one can direct it to the desired offset for code execution 553, thus gaining instruction control point 521. Craft trigger 525 may trigger memory 545.

If instruction controlled point 521 is reached, any code may be executed, sometimes with size limitations which may be solvable by many implementations of conditional fragmentation, download and execute, and many other ways known in the art used for post-exploitation, but only after control is reached. The novelty of the kernel object components and especially the enforcer and verifier, allows the threat to be detected automatically, within block 513 of the diagram.

### References

Uml http://www.ibm.comdeveloperworks/rational/library/3101.html

Zuk, 2010

https://media.blackhat.com/bh-dc-11/Avraham/BlackHat DC 2011 Avraham ARM % 20Exploitaion-wp.2.0.pdf

Miller, usenix, 2008

www.usenix.org/event/woot08/tech/full_papers/daniel/daniel.pdf

Heap Overflow

http://blogs.cisco.com/security/exploring heap-based buffer overflows with the application verifier/

Ineger Overflow CVE

http://xforce.iss.net/xforce/xfdb/53934
k-int http://pdos.csail.mit.edu/papers/kint:osdi12.pdf

In order to simplify the present description some of the details provided in U.S. application Ser. No. 13/865,212 entitled “PREVENTIVE INTRUSION DEVICE AND METHOD FOR MOBILE DEVICES” are not repeated, and U.S. application Ser. No. 13/865,212 is incorporated herein by reference.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

The present embodiments apply to wireless networks including WiFi (such as IEEE 802.11a,b,c,d,e,f, etc.) but not limited thereto. The embodiments are also relevant to Code Division Multiple Access (CDMA), CDMA-2000 and wideband CDMA (WCDMA) cellular radiotelephone receivers for receiving spread spectrum signals, Global System for Mobile communication (GSM) cellular radiotelephone, General Packet Radio Service (GPRS), Extended GPRS (EGPRS), third generation cellular systems (3G), 3GPP Long Term Evaluation (LTE) and the like. For simplicity, although the scope of the invention is in no way limited in this respect, embodiments of the invention described below may be related to a CDMA family of cellular radiotelephone systems that may include CDMA, WCDMA, CDMA 2000 and the like. Alternatively, embodiments of the invention may well be implemented in wireless data communication networks such as those defined by the Institute for Electrical and Electronics Engineers (IEEE).

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A computerized system for preventing host intrusions on a communication device, said device is wirelessly connected to a wireless communication network, said system comprising:
a computer readable management software module configured to analyze malicious payloads in said network said management software module comprising:
a) an asset manager module configured to assign updates or patches to the communication device;
b) a device database module configured to describe the communication device characteristics and configurations;
c) a build database module configured to automate software builds or versioning of software updates of said communication device core operating system;
d) a component builder module configured to run a plurality of instruction sets to establish a build environment for said communication device according to the communication device characteristics;
e) a configuration manager module configured to build the instruction sets; and
f) an operating system product module configured by said build database module as part of a build process triggered by said asset manager module.

2. The system of claim 1, wherein said management software module is configured to monitor the execution and behavior of a network application or network packet which is in communication with said device.

3. The system of claim 1, wherein said management software module is configured to gather a whitelist of processes that are allowed to breach normal execution behavior.

4. The system of claim 3, wherein said whitelist of processes are updated from a daemon privileged process.

5. The system of claim 1, wherein said management software module is configured to predict malicious payloads.

6. The system of claim 5 wherein said prediction is configured according to a post-execution behavior model, which is based on behavioral analysis performed after code execution.

7. The system of claim 1, wherein said management software module is configured to prevent execution of unknown malicious payloads to services or processes running on said communication device.

8. The system of claim 1 wherein said management software module is a cloud based software module.

9. The system of claim 1, wherein said instruction sets are executed by a target component builder.

10. The system of claim 1, wherein said instruction sets are configured to embed automatically components selected from the group consisting of: build scripts, programs and instructions.

11. The system of claim 10, wherein the build scripts are configured to use the device build environment module to generate a software patch or product.

12. The system of claim 1 wherein said communication device is selected from the group consisting of: mobile device , phone, smart phone, laptop or tablet.

13. The system of claim 1 wherein the asset manager is located in said communication device or within the management software module.

14. The system of claim 1, wherein said operating system product module is a binary patch to an operating system component or a third party application, or software module.

15. A method for preventing host intrusions on a communication device in a wireless communication network, the method comprising:
issuing by an asset manager module software a request for software updates or patches of said communication device type;
processing said request by a management module;
inserting said request to a build database module;
polling or triggering a configuration manager module to construct a plurality of instructions by said configuration manager module;
transmitting the constructed requests to a component builder module;
loading a template by said component builder module to generate a build template for said communication device; and
running said build template to produce a final operating system product module to said communication device.

16. The method of claim 15 comprising issuing a set of queries by said component builder module, if no template is available, to generate a build template for said communication device.

17. The method of claim 15 comprising:
querying said communication device when said communication device wirelessly connects to the software management module; and
notifying said communication device on the existence of new updates.

18. The method of claim 15, wherein said request is processed on said software management module and inserted to said build database module.

19. A method for preventing host attacks on a communication device using a computerizes system comprising at least a kernel object, an assets manager, a cloud-based, automatic behavioral engine and a virtual machine, the method comprising:
implementing a virtual machine which has the kernel object running on it;
downloading a document from the Internet, or downloading anything that could arbitrarily be used to implement code;
running the code over the cloud over the virtual machine;
detecting the codes' execution alteration in real time and preventing execution of the code; and
enabling the kernel object to be responsible to make sure it did not alter the execution.
